(19) United States
(12) Patent Application Publication
(10) Pub. No.: US 2021/0382617 A1
(43) Pub. Date: Dec. 9, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kengo TOKUCHI, Kanagawa (JP)

(73) Assignee: FUJIFILM BUSINESS INNOVATION CORP., Tokyo (JP)

(21) Appl. No.: 17/109,756

(22) Filed: Dec. 2, 2020

(30) Foreign Application Priority Data
Jun. 5, 2020 (JP) 2020-098493

(51) Int. Cl. G06F 3/0488; G06F 1/16; G04G 9/00; G04G 21/02; G06F 3/0485

(52) U.S. Cl. CPC G06F 3/04886; G06F 1/163; G04G 9/0017; G06F 3/0485; G04G 21/02; G06F 1/1639; G06F 1/1652; G04G 9/007

(57) ABSTRACT

An information processing apparatus includes a processor configured to detect a viewable region of a display surface on a user, the viewable region being viewable from the user, and display predetermined information in an area including the center of the viewable region.

### CROSS-REFERENCE TO RELATED APPLICATIONS

This application is based on and claims priority under 35 USC 119 from Japanese Patent Application No. 2020-098493 filed Jun. 5, 2020.

### BACKGROUND

### (i) Technical Field

The present disclosure relates to an information processing apparatus and a non-transitory computer readable medium.

### (ii) Related Art

Wearable devices have recently been put to practical use. Examples of this type of device include devices that are used by being attached to wrists and the like. Some devices of this type each have a limitation on the positional relationship between a wrist and the device being worn around the wrist due to the structure of the device, and some of devices of this type do not have such a limitation. In the latter case, the devices may be freely worn. Japanese Unexamined Patent Application Publication No. 2015-179299 is an example of the related art.

For example, there is a device having a display surface extending approximately halfway around a wrist in the state where the device is worn around the wrist. When a display of the device displays information, attention-grabbing information is often displayed near the center of the display surface in the longitudinal direction of the display surface. In many cases, the structure of such a device is designed in such a manner that a region of the display surface near the center of the display surface in the longitudinal direction is located at a position where a user may easily look at the region when the device is worn by the user.

However, if the device is not fixedly worn on a body part, and the positional relationship between the body part and the display surface in the longitudinal direction changes, the central region of the display surface in the longitudinal direction will not always be located at a position where the user may easily look at the central region. In such a case, the user needs to change their posture and adjust the angle of the display surface in order to easily look at the display surface. In addition, in the case where the display surface has a ring-like shape, the center of the display surface in the longitudinal direction is not definable.

### SUMMARY

Aspects of non-limiting embodiments of the present disclosure relate to making it easier for a user to look at predetermined information compared with the case where a device to be used by being worn by a user displays information items in an arrangement that is set without taking into consideration the viewability of a display surface for a user when the user looks at the display surface.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to detect a viewable region of a display surface on a user, the viewable region being viewable from the user, and display predetermined information in an area including the center of the viewable region.

### BRIEF DESCRIPTION OF THE DRAWINGS

Exemplary embodiments of the present disclosure will be described in detail based on the following figures, wherein:

FIGS. 1A to 1C are diagrams illustrating an example of a wearable terminal that is used in a first exemplary embodiment, FIG. 1A, FIG. 1B, and FIG. 1C being respectively a perspective view of the terminal, a side view of the terminal, and a diagram illustrating an example of how to wear the terminal;

FIG. 2 is a diagram illustrating an example of a configuration of a signal system of the wearable terminal;

FIG. 3 is a flowchart illustrating an example of a processing operation that is performed in the terminal of the first exemplary embodiment;

FIGS. 4A to 4C are diagrams illustrating a relationship between the posture of a user who looks at the terminal worn around the user's left wrist and an arrangement of information relating to the time, FIG. 4A, FIG. 4B, and FIG. 4C respectively being a diagram illustrating the user wearing the terminal when viewed from the front, a diagram illustrating the user wearing the terminal when viewed from the side, and a diagram illustrating an image of a face that is captured by a camera and an arrangement of the information relating to the time;

FIG. 5 is a diagram illustrating a positional relationship between the time, which is an information item displayed near the center of a viewable area, and the other information items;

FIGS. 6A to 6C are diagrams illustrating another relationship between the posture of the user who looks at the terminal worn around the user's left wrist and an arrangement of the information relating to the time, FIG. 6A, FIG. 6B, and FIG. 6C respectively being a diagram illustrating the user wearing the terminal when viewed from the front, a diagram illustrating the user wearing the terminal when viewed from the side, and a diagram illustrating an image of a face that is captured by the camera and an arrangement of the information relating to the time;

FIG. 7 is a diagram illustrating a positional relationship between the time, which is an information item displayed near the center of a viewable area, and the other information items;

FIGS. 8A to 8E are diagrams illustrating an example of an operation for changing an arrangement of low-priority information items, FIG. 8A illustrating the arrangement before the operation is accepted, and FIGS. 8B to 8E each illustrating an arrangement after the operation has been accepted;

FIGS. 9A and 9B are diagrams illustrating an example of an operation for changing the position of a high-priority information item, FIG. 9A illustrating the arrangement before the operation is accepted, and FIG. 9B illustrating the arrangement after the operation has been accepted;

FIGS. 10A and 10B are diagrams illustrating another example of the operation for changing the position of a high-priority information item, FIG. 10A illustrating the arrangement before the operation is accepted, and FIG. 10B illustrating the arrangement after the operation has been accepted;

FIGS. 11A and 11B are diagrams illustrating an example of an operation for accepting a change of the display form of a high-priority information item, FIG. 11A illustrating the display form before the operation is accepted, and FIG. 11B illustrating the display form after the operation has been accepted;

FIGS. 12A to 12C are diagrams illustrating an example of a wearable terminal that is used in a second exemplary embodiment, FIG. 12A, FIG. 12B, and FIG. 12C being respectively a perspective view of the terminal, a side view of the terminal, and a diagram illustrating an example of how to wear the terminal;

FIG. 13 is a diagram illustrating an example of a configuration of a signal system of the wearable terminal;

FIG. 14 is a flowchart illustrating an example of a processing operation that is performed in the terminal of the second exemplary embodiment;

FIGS. 15A and 15B are diagrams illustrating a setting example of a viewable area in the case where a mark printed on a body of the terminal is located on the upper side, FIG. 15A illustrating an example of how to wear the terminal, and FIG. 15B illustrating a relationship between a position where the terminal is in contact with a wrist and the viewable area;

FIGS. 16A and 16B are diagrams illustrating a setting example of a viewable area in the case where the mark printed on the body of the terminal is located on the lower side, FIG. 16A illustrating an example of how to wear the terminal, and FIG. 16B illustrating a relationship between a position where the terminal is in contact with a wrist and the viewable area;

FIGS. 17A to 17C are diagrams illustrating an example of a wearable terminal that is used in a third exemplary embodiment, FIG. 17A, FIG. 17B, and FIG. 17C being respectively a perspective view of the terminal, a side view of the terminal, and a diagram illustrating an example of how to wear the terminal;

FIG. 18 is a diagram illustrating an example of a configuration of a signal system of the wearable terminal;

FIG. 19 is a flowchart illustrating an example of a processing operation that is performed in the terminal of the third exemplary embodiment;

FIGS. 20A and 20B are diagrams illustrating an example of a wearable terminal that is used in a fourth exemplary embodiment, FIG. 20A illustrating a basic shape of the terminal, and FIG. 20B illustrating the terminal after its shape has been altered;

FIGS. 21A and 21B are diagrams illustrating an example of a wearable terminal that is used in a fifth exemplary embodiment, FIG. 21A being a perspective view of the terminal in a stretched state, and FIG. 21B being a perspective view of the terminal whose shape has been altered;

FIG. 22 is a diagram illustrating an output example of infrared light beams that are output by infrared sensors;

FIG. 23 is a diagram illustrating an example of a configuration of a signal system of the wearable terminal;

FIG. 24 is a flowchart illustrating an example of a processing operation that is performed in the wearable terminal of the fifth exemplary embodiment; and

FIGS. 25A to 25C are diagrams illustrating usage examples of the terminal of the fifth exemplary embodiment, FIG. 25A illustrating the state before a display surface is projected by a projector, FIG. 25B illustrating a case in which the projector projects the display surface on the palm side, and FIG. 25C illustrating a case in which the projector projects the display surface on the back side of a hand.

### DETAILED DESCRIPTION

### Exemplary embodiments of the present disclosure will be described below with reference to the drawings.

### First Exemplary Embodiment

### Device Configuration

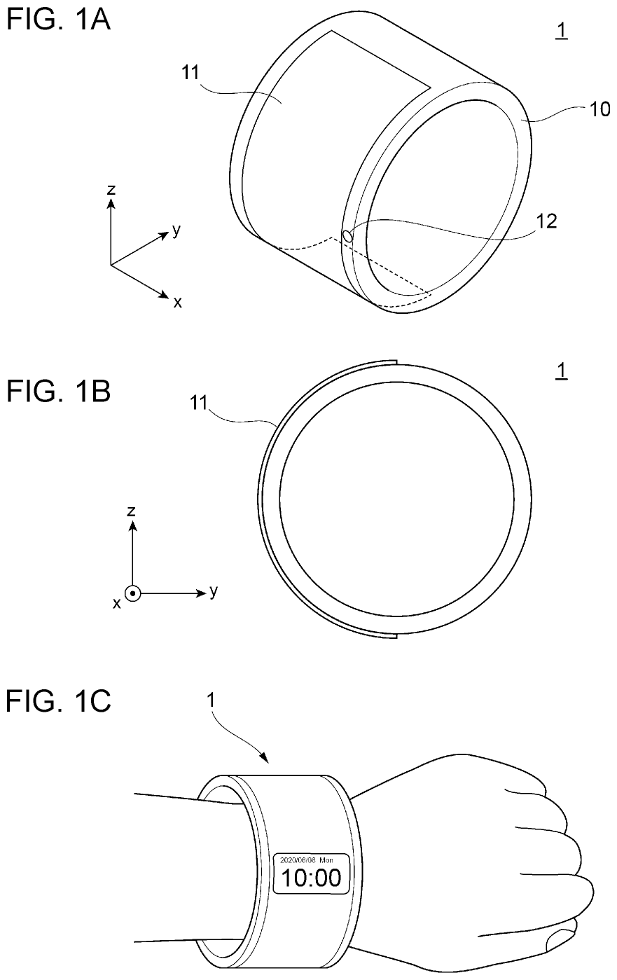

FIGS. 1A to 1C are diagrams illustrating an example of a wearable terminal 1 that is used in the first exemplary embodiment. FIG. 1A, FIG. 1B, and FIG. 1C are respectively a perspective view of the terminal 1, a side view of the terminal 1, and a diagram illustrating an example of how to wear the terminal 1.

The terminal 1 used in the first exemplary embodiment is used by being worn around a wrist. A body 10 of the terminal 1 has a substantially cylindrical shape. Note that a slit may be formed in a portion of the body 10, and the slit may be expanded when a user wears and takes off the terminal 1.

A display 11 and a camera 12 are provided on the outer peripheral surface of the body 10. The display 11 is, for example, an organic electro luminescence (EL) display and has a shape curved along the outer peripheral surface of the body 10, that is, a shape having a curved surface. When the body 10 is deformed, the display 11 is also deformed integrally with the body 10.

In the case illustrated in FIGS. 1A to 1C, the single display 11 is provided and extends approximately halfway around the outer peripheral surface of the body 10. In other words, the display 11 has a semicylindrical shape. Although the single display 11 is provided in the case illustrated in FIGS. 1A to 1C, a plurality of displays 11 may be provided. In the case where a plurality of displays 11 are provided, the displays 11 may have the same size or may have different sizes.

Alternatively, a plurality of displays 11 may be connected to each other so as to form a single display surface. Obviously, the plurality of displays 11 may be arranged in such a manner as to be spaced apart from each other. Note that the plurality of displays 11 may be spaced apart from each other in the circumferential direction of the body 10 or may be spaced apart from each other in the X-axis direction, which is a heightwise direction.

In the configuration example illustrated in FIGS. 1A to 1C, the length of the display 11 in the x-axis direction is shorter than the length of the body 10 in the x-axis direction. In other words, the length of the semicylindrical shape of the display 11 in the heightwise direction is shorter than the length of the substantially cylindrical shape of the body 10. Accordingly, regions each having a semiring-like shape are formed on the left and right sides of the display 11 illustrated in FIG. 1A, and these regions are not used for displaying information. The camera 12 illustrated in FIG. 1A is disposed in one of these regions, each of which has a semiring-like shape.

In the first exemplary embodiment, the single camera 12 is provided at a position near the center of the display 11 in the circumferential direction of the display 11.

Thus, when a user looks at an area near the center of the display 11 from the front, the user's face is located substantially at the center in an image captured by the camera 12.

It goes without saying that the camera 12 may at least be positioned outside the display 11. However, the camera 12 in the first exemplary embodiment is used for determining the location of a user who looks at the display 11, and thus, the camera 12 needs to be disposed in the vicinity of the display 11.

The terminal 1 in the first exemplary embodiment is an example of an information processing apparatus.

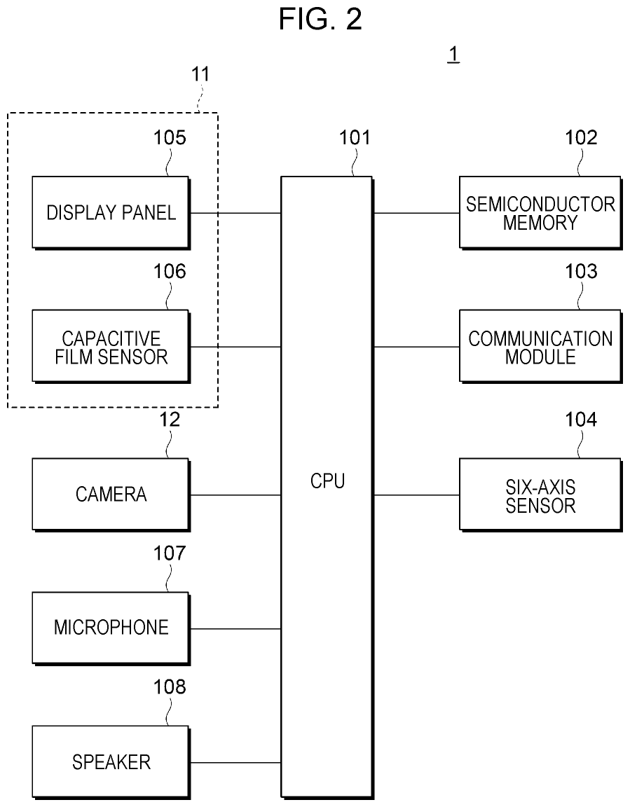

FIG. 2 is a diagram illustrating an example of a configuration of a signal system of the wearable terminal 1. The terminal 1 includes a central processing unit (CPU) 101 that performs overall control of the device, a semiconductor memory 102 that stores programs and data, a communication module 103 that is used in communication with the outside, a six-axis sensor 104 that detects the movement and posture of a user wearing the terminal 1, a display panel 105 that displays information, a capacitive film sensor 106 that detects a user operation performed on a displayed image, the camera 12, a microphone 107, and a speaker 108.

The CPU 101 in the first exemplary embodiment sets the arrangement of information items that are displayed on the display 11 through execution of a program. The CPU 101 is an example of a processor. The CPU 101 and the semiconductor memory 102 forms a computer.

The semiconductor memory 102 includes a storage device that is used as a work area and a rewritable non-volatile storage device that is used for storing data. The former storage device is a so-called random access memory (RAM), and the latter storage device is a so-called flash memory. Firmware is stored in the flash memory.

The communication module 103 is, for example, a Bluetooth (Registered Trademark) module or a wireless local area network (LAN) module.

The six-axis sensor 104 is a sensor that measures the position and the angular velocity of the terminal 1 and is formed of a three-axis acceleration sensor and a three-axis gyro sensor. Note that a nine-axis sensor that includes a three-axis orientation sensor may be employed instead of the six-axis sensor 104.

The display panel 105 and the capacitive film sensor 106 are included in the above-mentioned display 11. The capacitive film sensor 106 is stacked on a surface of the display panel 105 so as to form a touch panel. The capacitive film sensor 106 has a property of enabling a user to see information displayed on the display panel 105.

In addition, the capacitive film sensor 106 detects, from a change in electrostatic capacitance, the position at which a user makes a tap or the like. The display panel 105 is a so-called output device, and the capacitive film sensor 106 is a so-called input device.

The camera 12 is, for example, a complementary metal oxide semiconductor (CMOS) sensor. The camera 12 is an example of an imaging device.

The microphone 107 is a device that converts a user's voice and ambient sound into electric signals.

The speaker 108 is a device that converts an electrical signal into audio and outputs the audio.

### Processing Operation

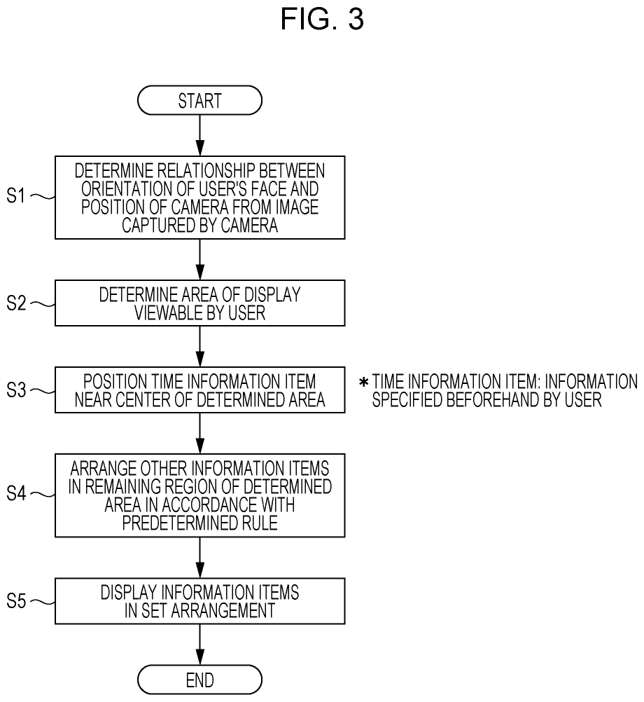

FIG. 3 is a flowchart illustrating an example of a processing operation that is performed in the terminal 1 of the first exemplary embodiment (see FIGS. 1A to 1C). Note that FIG. 3 illustrates a processing operation for setting the arrangement of information items that are displayed on the display 11 (see FIGS. 1A to 1C). In FIG. 3, the letter “S” is an abbreviation for “step”.

In the first exemplary embodiment, the CPU 101 (see FIG. 2) determines, from an image captured by the camera 12 (see FIGS. 1A to 1C), the relationship between the orientation of a user's face and the position of the camera 12 (step 1).

For example, the CPU 101 determines the relative positional relationship between the user and the camera 12 by detecting the position or the size of a user's face in an image captured by the camera 12.

In a captured image, the size of the face of a user who is closer to the camera 12 is larger than the size of the face of a user who is farther from the camera 12.

When a user looks at the display 11 from the front, the user's face is located substantially at the center in an image captured by the camera 12. In contrast, when a user looks at the display 11 in an oblique direction, the user's face is located at the periphery of an image captured by the camera 12.

As described above, the CPU 101 determines the orientation of a user's face and the positional relationship between the user and the camera 12 on the basis of the size or the position of the user's face captured in an image.

Alternatively, the orientation of a user's face may be determined from the positional relationship or the size relationship between the facial parts captured an image.

For example, when user's facial parts such as eyes, a nose, a mouth, and ears are symmetrically located, the user is looking at the display 11 from the front. In other words, the user's face is oriented in the direction in which the user faces the display 11.

When a user's forehead is large, and the user's chin is small in an image, the user's face is presumed to be oriented in a direction in which the user looks up at the display 11. When the left side of a user's face is large and the right side of the user's face is small or is not visible in an image, the user's face is presumed to be oriented in a direction in which the user looks at the display 11 from the right-hand side.

The direction in which a user looks at the display 11 is presumable also from the position of a pupil in the user's eye. Here, the direction in which the user looks at the display 11 is the direction of the user's line of sight. For example, when a user's pupil is located on the upper side in the user's eye, it is understood that the user is looking up at the display 11, and when the pupil is located on the lower side in the eye, it is understood that the user is looking down at the display 11. Similarly, when the pupil is located on the left side in the eye, it is understood that the user is looking at the display 11 from the right-hand side, and when the pupil is located on the right side in the eye, it is understood that the user is looking at the display 11 from the left-hand side.

When the relationship between the orientation of a user's face and the position of the camera 12 is determined, the relationship between the orientation of the user's face and the position of the display 11 is also determined.

Note that a user's face does not need to be entirely captured in an image for detection of the positional relationship. In addition, by registering a user's face beforehand, the positional relationship is determined with higher accuracy.

Faces other than the face of a user wearing the terminal 1 (see FIGS. 1A to 1C) may be excluded from being subjected to detection. For example, when the size of a face that is detected from an image captured by the camera 12 is smaller than a predetermined area, or when the number of pixels of the detected face is less than the predetermined number of pixels, the detected face may be considered not to be the face of a person who is looking at the display 11 and excluded from being a target for the positional relationship determination. Naturally, in the case where the terminal 1 is equipped with a distance-measuring sensor, information regarding the distance from the distance-measuring sensor to an object that is identified as a human face may be obtained by the distance-measuring sensor, and when the physical distance exceeds a threshold, the object may be excluded from a candidate for a user who is looking at the display 11.

Once the relationship between the orientation of the user's face and the position of the camera 12 has been determined, the CPU 101 determines an area of the display 11 that is viewable from the user (step 2).

In the first exemplary embodiment, the surface of the display 11 is curved. Thus, the entire display 11 is not always viewable depending on the relationship between the orientation of the user's face and the display 11. For example, a portion of the display 11 having the curved display surface, the portion being located in the user's blind spot, is not viewable from the user. Accordingly, the CPU 101 determines, from the determined relationship between the orientation of the user's face and the position of the camera 12, an area that is viewable from the user. More specifically, the CPU 101 determines a viewable area by also using the curvature of the display 11.

When the area that is viewable from the user is determined, the CPU 101 positions an information item regarding the time (hereinafter referred to as “time information item”) near the center of the determined area (step 3). Here, the time information item is an example of an information item that is specified beforehand by the user.

In the first exemplary embodiment, an information item that is specified beforehand by a user is positioned at a location on the display 11 where the user may easily look at the information item, that is, the information item is positioned near the center of an area that is viewable from the user. Although FIGS. 1A to 1C illustrate the time information item as an example, the information item to be positioned near the center of the viewable area may be freely specified by a user. For example, a user may specify an information item regarding a phone call, an e-mail, weather forecast, traffic information, calendar, or the like as the information item to be positioned near the center of the viewable area.

An information item that is positioned near the center of an area viewable from a user is an information item that is desired to be preferentially viewed by the user.

In the first exemplary embodiment, an information item that is positioned near the center of an area viewable from a user will also be referred to as a high-priority information item. Note that the other information items that are not a high-priority information item will be referred to as low-priority information items. The priority of each information item is specified beforehand by a user. Note that a user may specify only the priority of an information item to be positioned near the center of a viewable area, and information items to which no priority is given may be regarded as low-priority information items.

In the first exemplary embodiment, although there is one high-priority information item, there may be a plurality of high-priority information items. Also in the case where there are a plurality of high-priority information items, these plurality of high-priority information items are preferentially arranged near the center of a viewable area.

Note that, in the case where priorities are assigned to a plurality of predetermined information items, the information item having a higher priority may be positioned closer to the center of a viewable area.

In the case where priorities are not assigned to a plurality of predetermined information items, a region that is required for displaying these information items may be secured near the center of a viewable area, and the information items may be uniformly arranged in the region.

Arrangement of information items may be changed over time in accordance with a predetermined rule. For example, the positions of information items may be interchanged, or information items may be cyclically moved in a predetermined direction.

Note that the display size of an information item that is positioned near the center of an area viewable from a user may be changed in accordance with the size of an area of the display 11 that is viewable from the user. For example, the information item that is displayed near the center of the viewable area may be enlarged or reduced in size so as to correspond to the size of the viewable area. Here, an information items to be displayed is enlarged or reduced in size by changing, for example, the size of an icon or the font size.

In the first exemplary embodiment, the size of a viewable area is determined by the length or the angle of the display surface in the circumferential direction. Obviously, if an information item to be displayed is simply reduced in size, it may sometimes become difficult to see the information item. In such a case, the display size may be set so as not to be reduced to be smaller than a predetermined size. Similarly, the size of the information item to be displayed may be set so as not to be enlarged to be larger than a predetermined size.

Alternatively, the size of an information item to be displayed may be set to a fixed size regardless of an area that is viewable from a user. In this case, if the viewable area is too small for the size required for displaying the information item, the information item may be viewed by a scroll operation.

In addition, the number of information items to be displayed may be increased or decreased in accordance with the viewable area.

Once the position of the time information item has been set, the CPU 101 arranges the other information items in the remaining region of the determined area in accordance with a predetermined rule (step 4).

The other information items that are arranged in step 4 may be individually set by a user separately from the information item that is positioned near the center of the viewable area or may be set by the terminal 1 in accordance with a predetermined rule. In the case where the other information items are set by a user, the settings made by the user are given priority over the settings made in accordance with the rule.

The CPU 101 sets the arrangement of the information items in such a manner as to, for example, uniformly arrange the other information items in the remaining region. The arrangement may be set in accordance with the area of the remaining region and the contents of the other information items.

After that, the CPU 101 causes the information items to be displayed in the set arrangement (step 5).

### Arrangement Example

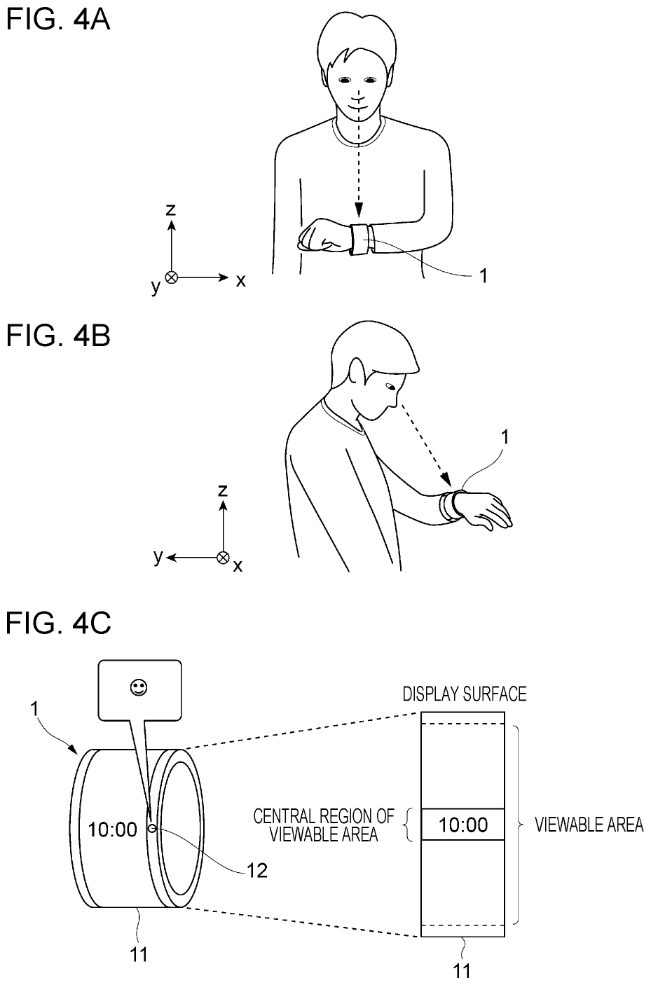

Differences in arrangement of information items according to the positional relationship between a user looking at the terminal 1 and the display 11 of the terminal 1 will be described below with reference to FIG. 4A to FIG. 7.

FIGS. 4A to 4C are diagrams illustrating a relationship between the posture of a user who looks at the terminal 1 worn around the user's left wrist and an arrangement of the time information item. FIG. 4A is a diagram illustrating the user wearing the terminal 1 when viewed from the front. FIG. 4B is a diagram illustrating the user wearing the terminal 1 when viewed from the side. FIG. 4C is a diagram illustrating an image of the user's face captured by the camera 12 and an arrangement of the information item relating to the time.

The user illustrated in FIGS. 4A to 4C raises their left wrist wearing the terminal 1 to the height of their chest and looks down at the display 11 of the terminal 1 from above. Thus, the user's face is located near the center of the image captured by the camera 12.

The CPU 101 (see FIG. 2) determines, from the relationship between the camera 12 and the orientation of the user's face, that substantially the entire display 11 is viewable from the user. In the case illustrated in FIGS. 4A to 4C, an area extending to the vicinity of the two ends of the display 11 is determined to be a viewable area. Thus, a central region of the viewable area overlaps a region in which the camera 12 is located. In the case illustrated in FIGS. 4A to 4C, the time is displayed next to the camera 12.

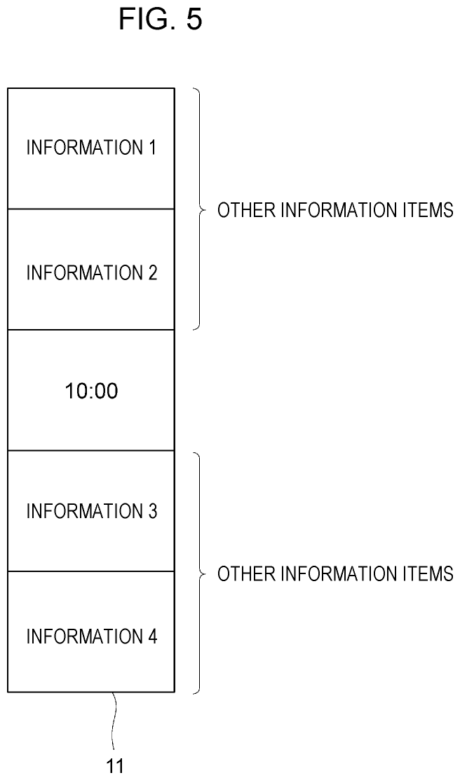

FIG. 5 is a diagram illustrating a positional relationship between the time information item, which is an information item displayed near the center of a viewable area, and the other information items. In FIG. 5, the other information items are four information items “information 1”, “information 2”, “information 3”, and “information 4”. In FIG. 5, two of these information items are arranged above the time information item, and the other two information items are arranged below the time information item.

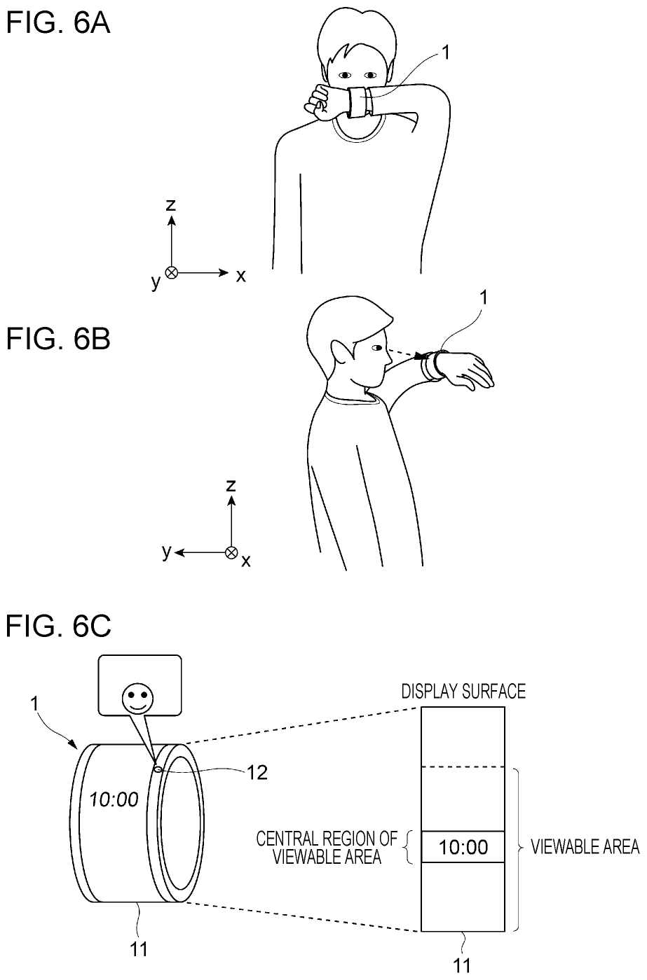

FIGS. 6A to 6C are diagrams illustrating another relationship between the posture of the user who looks at the terminal 1 worn around the user's left wrist and an arrangement of the time information item. FIG. 6A is a diagram illustrating the user wearing the terminal 1 when viewed from the front. FIG. 6B is a diagram illustrating the user wearing the terminal 1 when viewed from the side. FIG. 6C is a diagram illustrating an image of the user's face captured by the camera 12 and an arrangement of the information item relating to the time.

The user illustrated in FIGS. 6A to 6C raises their left wrist wearing the terminal 1 to the height of their face and looks at the display 11 of the terminal 1 from the side.

Thus, the user's face is located near the lower end of the image captured by the camera 12. The distance between the user's face and the camera 12 in the case illustrated in FIGS. 6A to 6C is shorter than the distance between the user's face and the camera 12 in the case illustrated in FIGS. 4A to 4C. In FIGS. 6A to 6C, the user's face captured by the camera 12 is illustrated in an enlarged manner compared with that in FIGS. 4A to 4C.

The CPU 101 (see FIG. 2) determines, from the relationship between the camera 12 and the orientation of the user's face, that approximately the half of the display 11 is the area viewable from the user. In FIGS. 6A to 6C, approximately the half of the display 11 on the front side, or approximately the half of the display 11 on the lower end side is determined to be the viewable area.

Thus, a central region of the viewable area is located near an intermediate position between the camera 12 and the lower end of the display 11. In FIGS. 6A to 6C, the time information item is displayed below the position of the camera 12.

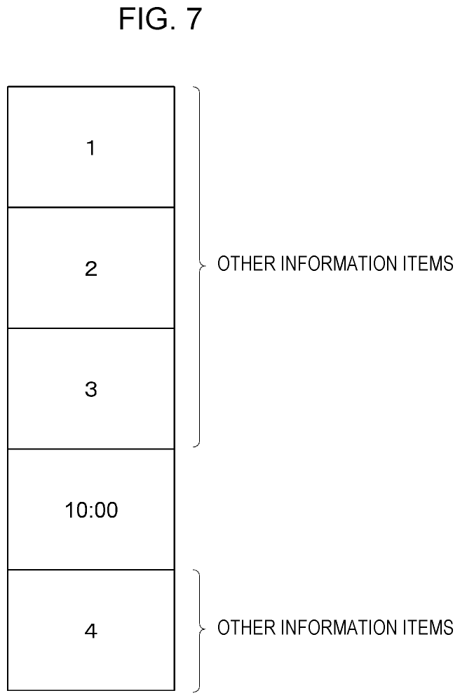

FIG. 7 is a diagram illustrating a positional relationship between the time information item, which is information that is displayed near the center of a viewable area, and the other information items. Also in the case illustrated in FIG. 7, the other information items are four information items “information 1”, “information 2”, “information 3”, and “information 4”. In FIG. 7, three of these information items are arranged above the time information item, and the remaining one information item is arranged below the time information item.

### Change of Information Arrangement, Etc.

An operation for changing an arrangement or the like of information items displayed on the display 11 and examples of arrangement change and so forth as a result of performing the operation will be described below.

### First Modification

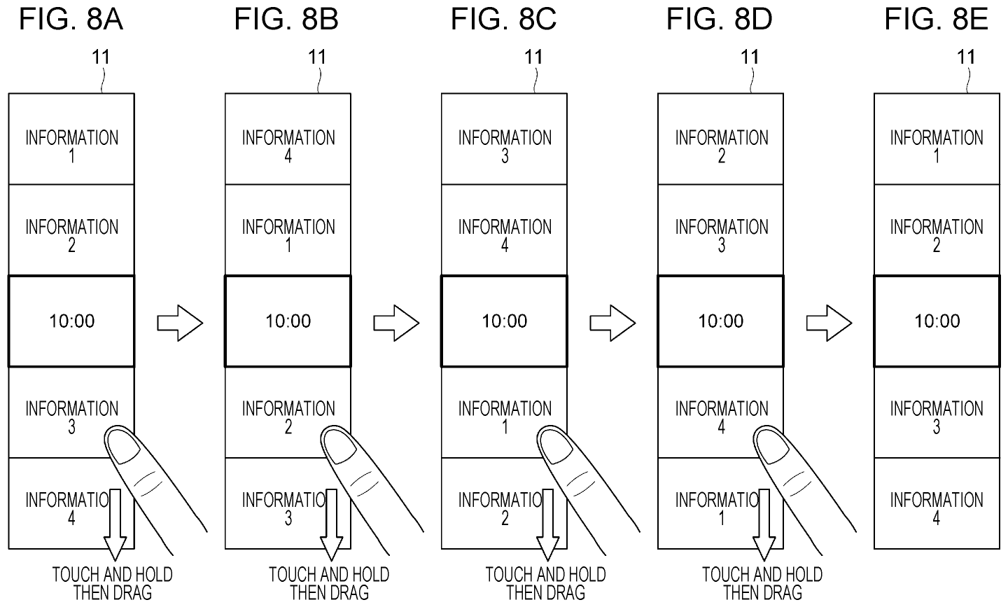

FIGS. 8A to 8E are diagrams illustrating an example of an operation for changing an arrangement of the low-priority information items. FIG. 8A illustrates the arrangement before the operation is accepted, and FIGS. 8B to 8E each illustrate an arrangement after the operation has been accepted.

In the case illustrated in FIGS. 8A to 8E, a user touches and holds an area other than the area of the time information item, which is a high-priority information item, then drags the area downward while keeping touching the area.

In the first modification, the CPU 101 determines whether an area touched and held by a user is a “central region of the area that is determined as viewable” or a “region of the viewable area other than the central region”. In the case illustrated in FIGS. 8A to 8E, a user touches and holds a “region of the viewable area other than the central region”. In other words, the user touches and holds a region in which one of the low-priority information items is located.

In the first modification, the CPU 101 accepts changes of the positions of all the low-priority information items displayed on the display 11.

The information items in FIG. 8A are arranged in the order of “information 1—information 2—time—information 3—information 4” from the top. In FIG. 8A, the user touches and holds the area of “information 3” then drags the area downward while keeping touching the area. As a result, the arrangement of the information items on the display 11 is changed to the arrangement illustrated in FIG. 8B, specifically, the information items are arranged in the order of “information 4—information 1—time—information 2—information 3”.

Subsequently, the four low-priority information items are cyclically moved each time the user performs the touch-hold and drag operation. Note that the time information item, which is a high-priority information item, is displayed at a fixed position.

In the case illustrated in FIGS. 8A to 8E, although all the low-priority information items are to be moved, only the information item located in the area touched and held by a user may be moved in such a manner that the information item and the low-priority information item that is adjacent to the information item in a direction in which the user drags the information item change their positions.

### Second Modification

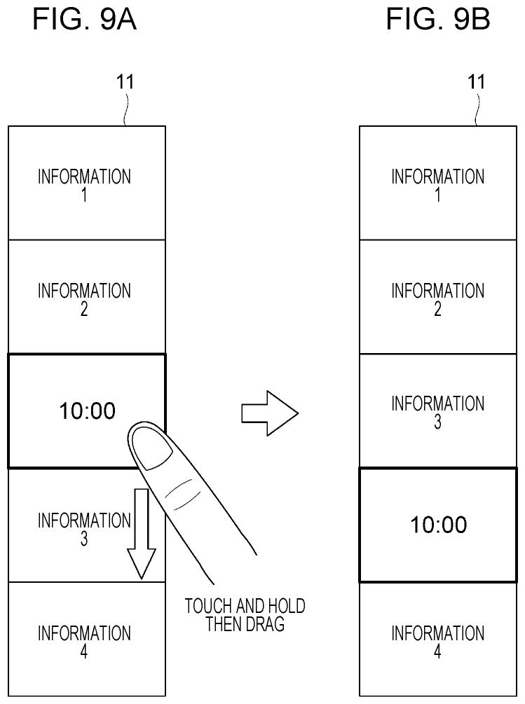

FIGS. 9A and 9B are diagrams illustrating an example of an operation for changing the position of a high-priority information item. FIG. 9A illustrates the arrangement before the operation is accepted, and FIG. 9B illustrates the arrangement after the operation has been accepted.

Although it is very likely that a central region of an area that is viewable from a user is easier for the user to look at than the other regions are, the user may sometimes desire to move a high-priority information item to a different position.

In the case illustrated in FIGS. 9A and 9B, the user touches and holds the area of the time information item, which is a high-priority information item, then drags the area downward while keeping touching the area.

In the second modification, since the area of the time information item, which is a high-priority information item, is touched and held, the CPU 101 accepts a change of the position of the high-priority information item.

The information items in FIG. 9A are arranged in the order of “information 1—information 2—time—information 3—information 4” from the top. In FIG. 9A, the user touches and holds the area of the “time” then drags the area downward while keeping touching the area. As a result, the arrangement of the information items on the display 11 is changed to the arrangement illustrated in FIG. 9B, specifically, the information items are arranged in the order of “information 1—information 2—information 3—time—information 4”.

In the case illustrated in FIGS. 9A and 9B, the “time”, which is touched and held, is moved in such a manner that the “time” and the “information 3”, which is adjacent to the “time” in the direction in which the user performs the drag operation, change their positions.

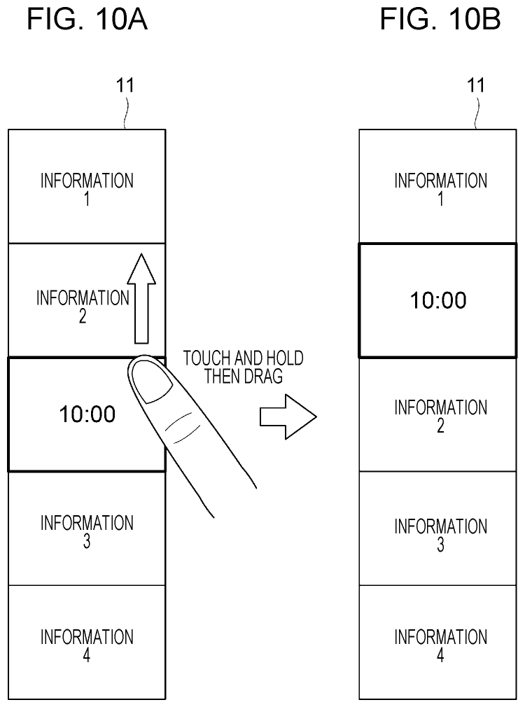

FIGS. 10A and 10B are diagrams illustrating another example of the operation for changing the position of a high-priority information item. FIG. 10A illustrates the arrangement before the operation is accepted, and FIG. 10B illustrates the arrangement after the operation has been accepted.

In the case illustrated in FIGS. 10A and 10B, a user touches and holds the area of the time information item, which is a high-priority information item, then drags the area upward while keeping touching the area.

The information items in FIG. 10A are also arranged in the order of “information 1—information 2—time—information 3—information 4” from the top. The user touches and holds the area of “time” then drags the area upward while keeping touching the area, and as a result, the arrangement of the information items on the display 11 is changed to the arrangement illustrated in FIG. 10B, specifically, the information items are arranged in the order of “information 1—time—information 2—information 3—information 4”.

Also in the case illustrated in FIGS. 10A and 10B, the “time”, which is touched and held, is moved in such a manner that the “time” and the “information 2”, which is adjacent to the “time” in the direction in which the user performs the drag operation, change their positions.

### Third Modification

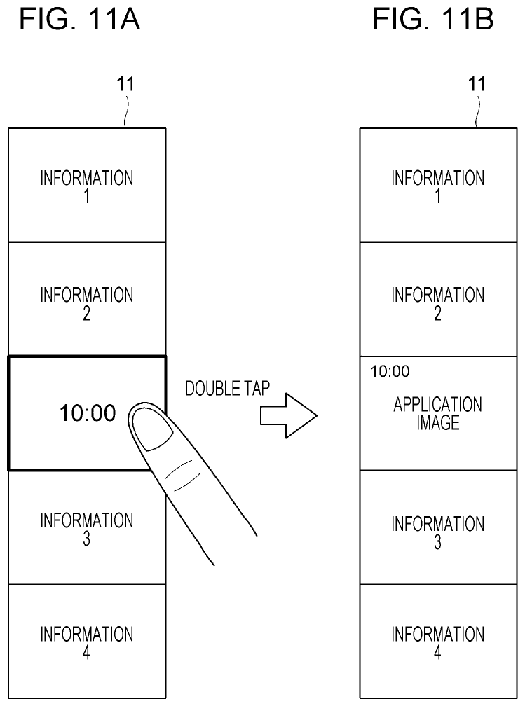

FIGS. 11A and 11B are diagrams illustrating an example of an operation for accepting a change of the display form of a high-priority information item. FIG. 11A illustrates the display form before the operation is accepted, and FIG. 11B illustrates the display form after the operation has been accepted.

In FIGS. 11A and 11B, a user double-taps the area of the time information item, which is a high-priority information item. The CPU 101 recognizes that the double tap is performed for changing the display form. In the case illustrated in FIGS. 11A and 11B, when the user performs a double tap, the CPU 101 recognizes that the double tap is performed in order to change the font size used for displaying the time information item and in order to change the position of the time displayed in the area of the time information item.

In FIG. 11B, the font size of the time displayed near the center of the display 11 is reduced, and the time is displayed at the upper left corner of the same area. An image of a predetermined application is displayed in the region in which the time had been displayed before the change. Examples of the application image include images streamed from the Internet, an image of a web page, and an image of an incoming call.

Note that, if the user double-taps the application image again, the display form of the time is changed back to the original display form.

When the terminal 1 receives a call or an e-mail, an image that represents the incoming call or e-mail may be displayed near the center of the display 11 without any user operation, and the time, which is a high-priority information item, may be displayed in the same area by reducing its font size as illustrated in FIG. 11B.

### Second Exemplary Embodiment

In the above-described first exemplary embodiment, an image captured by the camera 12 (see FIGS. 1A to 1C) is used for detecting an area of the display 11 that is viewable from a user who is wearing the terminal 1. In a second exemplary embodiment, however, an area that is viewable from a user is determined on the basis of a portion of the inner wall surface of the body 10 having a substantially cylindrical shape (see FIGS. 1A to 1C), the portion being in contact with a part of the user's body.

### Device Configuration

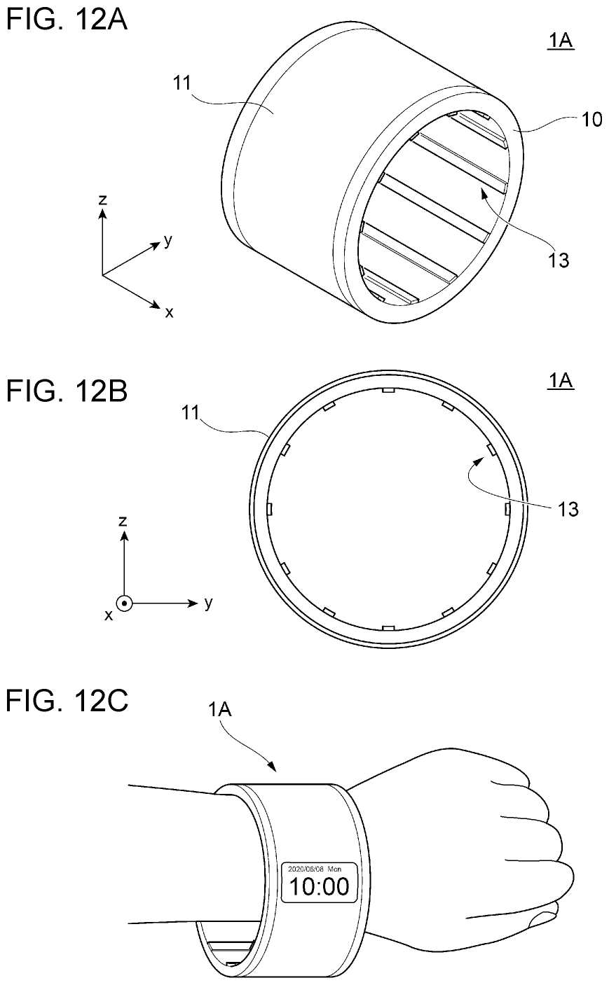

FIGS. 12A to 12C are diagrams illustrating an example of a wearable terminal 1A that is used in the second exemplary embodiment. FIG. 12A, FIG. 12B, and FIG. 12C are respectively a perspective view of the terminal 1A, a side view of the terminal 1A, and a diagram illustrating an example of how to wear the terminal 1A. In FIGS. 12A to 12C, components that correspond to those illustrated in FIGS. 1A to 1C are denoted by the same reference signs.

The terminal 1A that is used in the second exemplary embodiment is used by being worn around a wrist. The body 10 has a substantially cylindrical shape.

Note that the inner diameter of the body 10 in the second exemplary embodiment is larger than the diameter of a wrist around which the terminal 1A is to be worn. More specifically, a user may wear the terminal 1A by passing their hand through the opening of the body 10. Thus, the terminal 1A is wearable on a wrist without deforming the body 10. In the state where a user is wearing the terminal 1A, the position of the body 10 and the position of the user's wrist are not fixed with respect to each other. In other words, the body 10 is freely rotatable in the circumferential direction of the wrist.

The display 11 of the terminal 1A in the second exemplary embodiment has a substantially ring-like shape. In other words, the display 11 is provided in such a manner as to extend over substantially the entire circumferential surface of the body 10, which has a substantially cylindrical shape. Thus, an area that is viewable from a user is limited to a region of the substantially cylindrical shape that is oriented toward the user. However, in the case of the terminal 1A of the second exemplary embodiment, such a region that is oriented toward a user is not definable.

In the second exemplary embodiment, contact sensors 13 are arranged in such a manner as to be equally spaced on the inner peripheral surface of the body 10, that is, a surface of the body 10 that is opposite to the outer peripheral surface of the body 10 on which the display 11 is provided. In FIGS. 12A to 12C, twelve contact sensors 13 are arranged in such a manner as to be equally spaced. In the second exemplary embodiment, assume that a portion of the outer peripheral surface of the body 10 that is located at a position corresponding to the position on the inner peripheral surface of the body 10 where at least one of the contact sensors 13 detects contact with the user's body is oriented vertically upward.

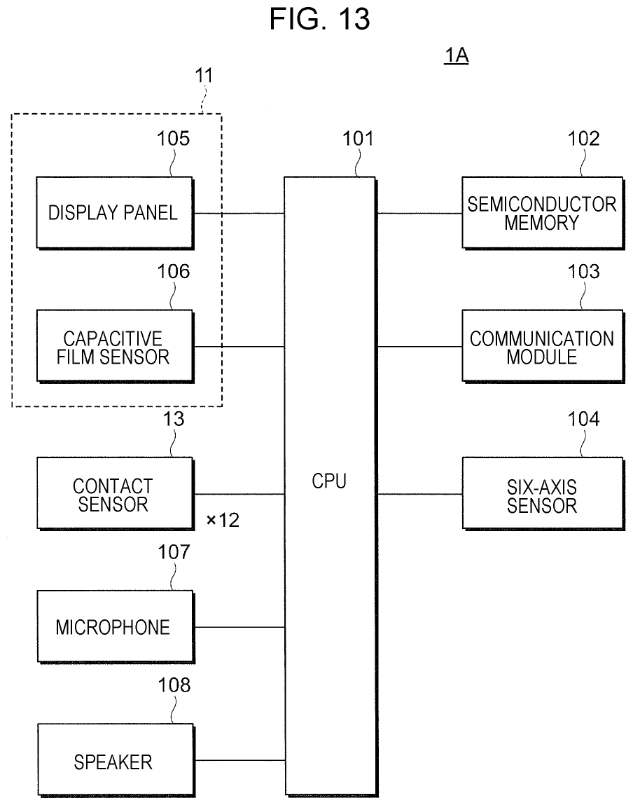

FIG. 13 is a diagram illustrating an example of a configuration of a signal system of the wearable terminal 1A. In FIG. 13, components that correspond to those illustrated in FIG. 2 are denoted by the same reference signs.

The terminal 1A includes the CPU 101 that performs overall control of the device, the semiconductor memory 102 that stores programs and data, the communication module 103 that is used in communication with the outside, the six-axis sensor 104 that detects the movement and posture of a user wearing the terminal 1A, the display panel 105 that displays information, the capacitive film sensor 106 that detects a user operation performed on the display panel 105, the contact sensors 13, the microphone 107, and the speaker 108.

The difference between the terminal 1A and the terminal 1 of the first exemplary embodiment is that the contact sensors 13 are used instead of the camera 12 (see FIGS. 1A to 1C) in the terminal 1A. For example, a sensor that detects contact with a user's skin on the basis of the on and off states of a physical switch, a sensor that detects a change in electric resistance due to contact with a user's skin, a sensor that detects a change in brightness, a pressure-sensitive sensor that detects pressure, a temperature sensor that detects the temperature of a user's skin, and a humidity sensor that detects a change in humidity due to contact with a user's skin is used as each of the contact sensors 13.

### Processing Operation

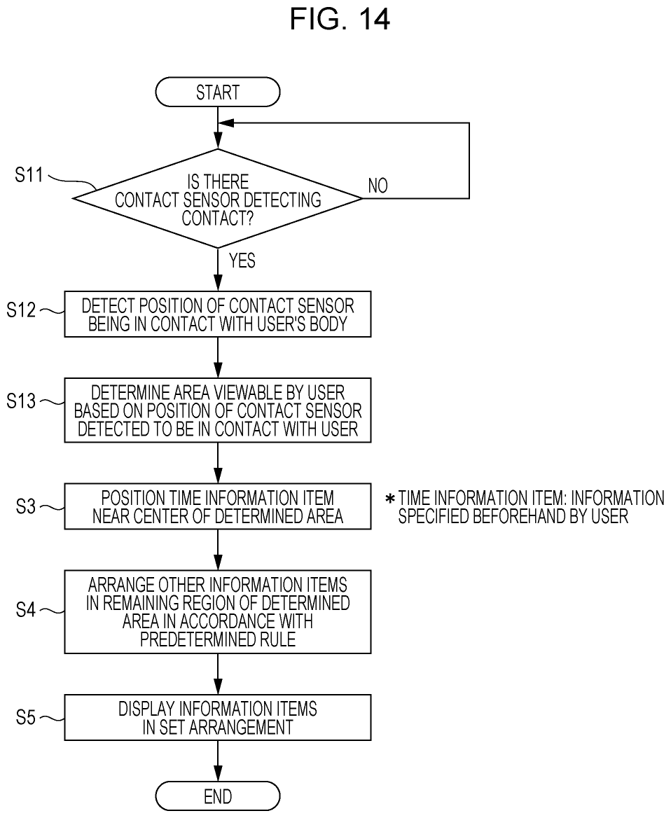

FIG. 14 is a flowchart illustrating an example of a processing operation that is performed in the terminal 1A of the second exemplary embodiment. Note that FIG. 14 illustrates a processing operation for setting the arrangement of information items that are displayed on the display 11 (see FIGS. 12A to 12C). In FIG. 14, steps that are the same as those in the flowchart illustrated in FIG. 3 are denoted by the same reference signs, and the letter “S” is an abbreviation for “step”.

In the second exemplary embodiment, the CPU 101 (see FIGS. 12A to 12C) determines whether any one of the contact sensors 13 detects contact (step 11).

When the terminal 1A is not worn by a user, the CPU 101 keeps outputting a negative result in step 11. During the period when the negative result is obtained in step 11, the CPU 101 repeats the determination in step 11.

When a user wears the terminal 1A on their wrist, and any one of the contact sensors 13 is brought into contact with a part of the user's body, an affirmative result is obtained in step 11.

When the affirmative result is obtained in step 11, the CPU 101 determines the position of the contact sensor 13 that is in contact with the user's body (step 12). The number of contact sensors 13 detected to be in contact with the user's body is not limited to one and may sometimes be two or more.

Next, the CPU 101 determines an area that is viewable from the user on the basis of the position of the contact sensor 13 detected to be in contact with the user's body (step 13). In the second exemplary embodiment, the area that is viewable from the user is determined on the assumption that the user looks at the display 11 such that the user looks down at a portion of the display surface that is located at a position corresponding to the position on the inner peripheral surface of the body 10 where the contact sensor 13 detects contact with the user's body.

Note that, in the case where two or more of the contact sensors 13 are detected to be in contact with the user's body, an intermediate position between the detected contact sensors 13 in the circumferential direction of the body 10 is calculated, and the viewable area is determined on the basis of the calculated position. The outer edge of a viewable area is calculated by using the curvature of the display unit 11.

Next, the CPU 101 positions the time information item near the center of the determined area (step 3). Subsequently, the CPU 101 arranges the other information items in the remaining region of the determined area in accordance with a predetermined rule (step 4) and causes the information items to be displayed in the set arrangement (step 5).

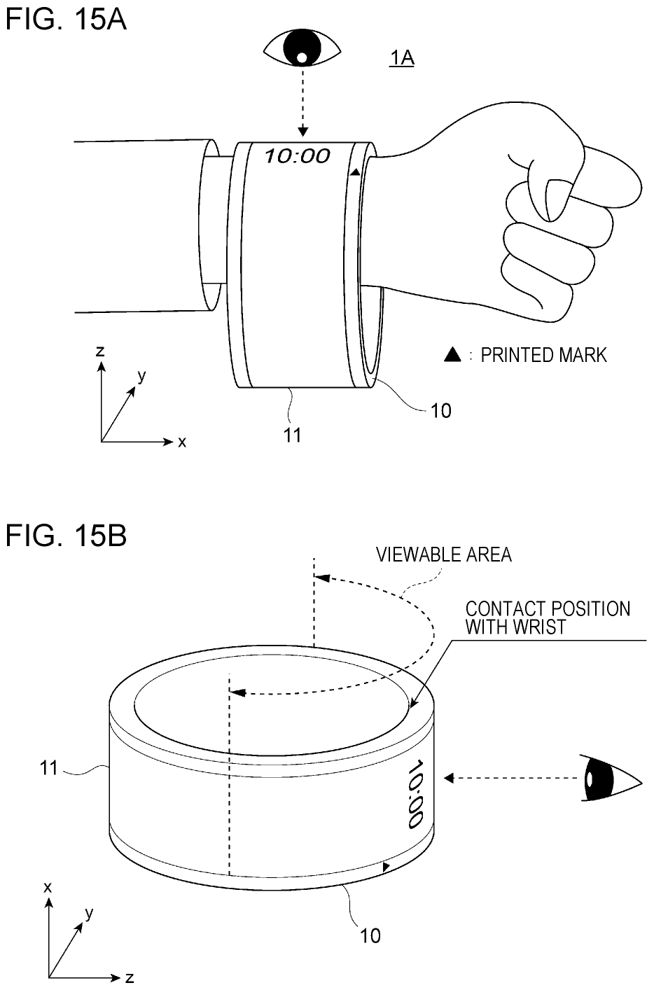

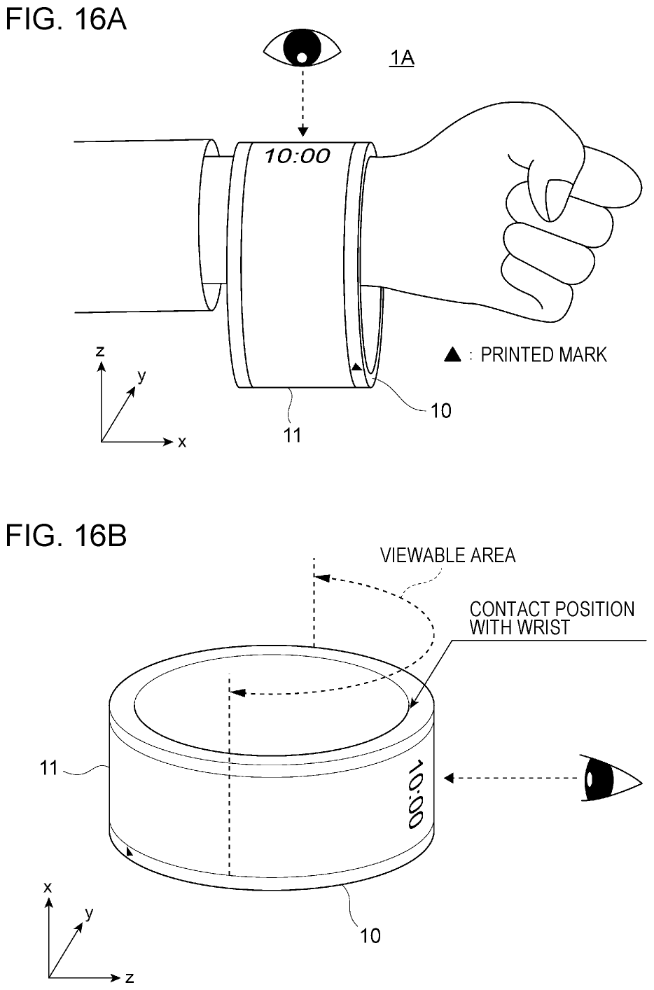

A specific example of a viewable area in the second exemplary embodiment will be described below with reference to FIG. 15A to FIG. 16B.

FIGS. 15A and 15B are diagrams illustrating a setting example of a viewable area in the case where a mark printed on the body 10 is located on the upper side. FIG. 15A illustrates an example of how to wear the terminal 1A, and FIG. 15B illustrates a relationship between a position where the terminal 1A is in contact with a wrist and the viewable area.

FIGS. 16A and 16B are diagrams illustrating a setting example of a viewable area in the case where the mark printed on the body 10 is located on the lower side. FIG. 16A illustrates an example of how to wear the terminal 1A, and FIG. 16B illustrates a relationship between a position where the terminal 1A is in contact with a wrist and the viewable area.

In the terminal 1A used in the second exemplary embodiment, substantially the entire circumferential surface of the body 10 serves as the display surface, and thus, a viewable area is set on the assumption that a portion of the body 10 that is in contact with a wrist is located on the upper side in the vertical direction.

The position of the printed mark illustrated in FIGS. 15A and 15B is different from the position of the printed mark illustrated in FIGS. 16A and 16B.

In the second exemplary embodiment, the time is displayed near the center of the area viewable from the user regardless of the position of the portion on which the mark is printed with respect to the wrist.

### Third Exemplary Embodiment

In the second exemplary embodiment, although an area that is viewable from a user is determined on the basis of a position at which at least one of the contact sensors 13 (see FIGS. 12A to 12C) detects contact, an area viewable from a user may be determined by the combination of a contact position detected by at least one of the contact sensors 13 and information included in an image captured by the camera 12 (see FIGS. 1A to 1C).

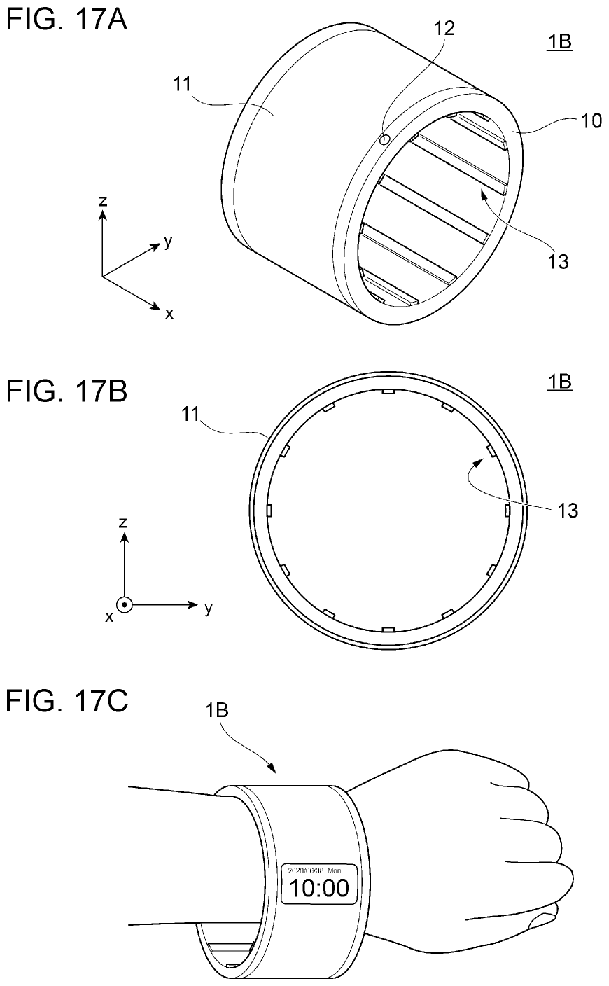

FIGS. 17A to 17C are diagrams illustrating an example of a wearable terminal 1B that is used in a third exemplary embodiment. FIG. 17A, FIG. 17B, and FIG. 17C are respectively a perspective view of the terminal 1B, a side view of the terminal 1B, and a diagram illustrating an example of how to wear the terminal 1B. In FIGS. 17A to 17C, components that correspond to those illustrated in FIGS. 1A to 1C and FIGS. 12A to 12C are denoted by the same reference signs.

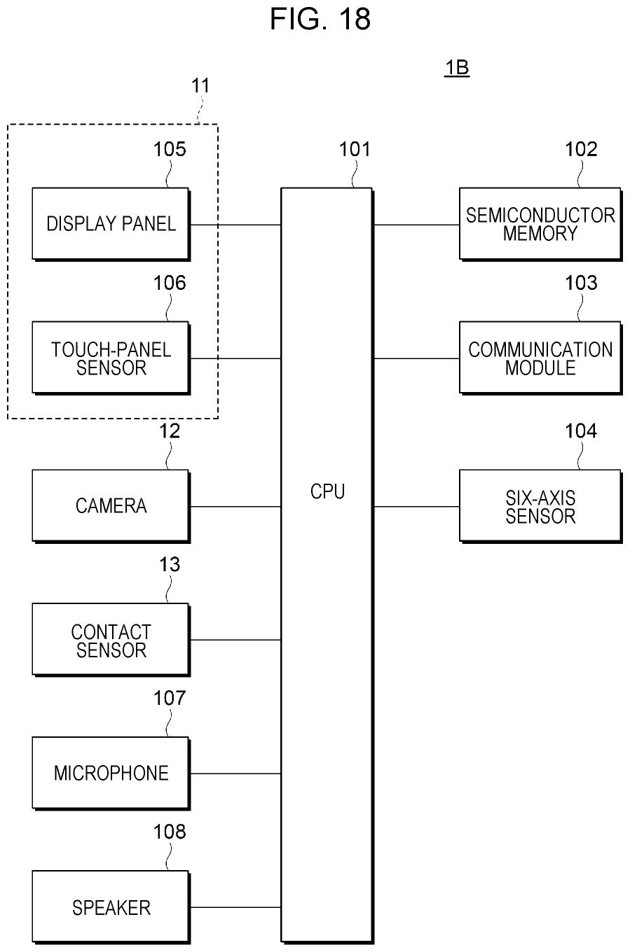

FIG. 18 is a diagram illustrating an example of a configuration of a signal system of the wearable terminal 1B. The terminal 1B includes the CPU 101 that performs overall control of the device, the semiconductor memory 102 that stores programs and data, the communication module 103 that is used in communication with the outside, the six-axis sensor 104 that detects the movement and posture of a user wearing the terminal 1B, the display panel 105 that displays information, the capacitive film sensor 106 that detects a user operation performed on the display panel 105, the camera 12, the contact sensors 13, the microphone 107, and the speaker 108.

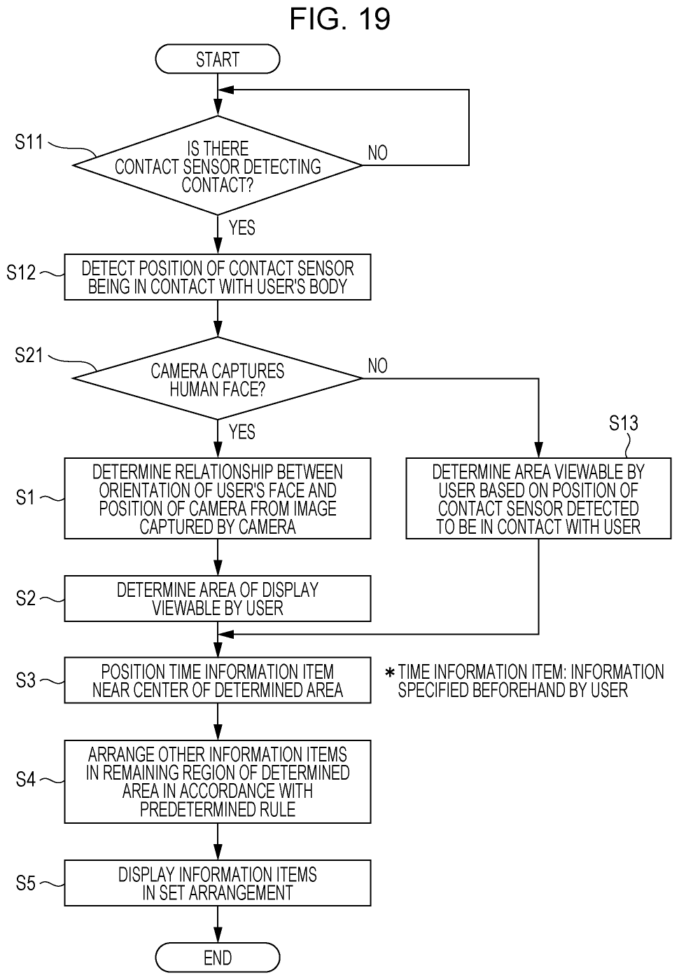

FIG. 19 is a flowchart illustrating an example of a processing operation that is performed in the terminal 1B of the third exemplary embodiment. Note that, in FIG. 19, steps that are the same as those in the flowcharts illustrated in FIG. 3 and FIG. 14 are denoted by the same reference signs, and the letter “S” is an abbreviation for “step”.

In the third exemplary embodiment, first, the CPU 101 determines whether any one of the contact sensors 13 detects contact (step 11), and if contact is detected, the CPU 101 determines the position of the contact sensor 13 that is in contact with a user's body (step 12).

After that, the CPU 101 determines whether there is a human face in an image captured by the camera 12 (step 21).

In the third exemplary embodiment, this is because only one camera 12 is provided even though the orientation of the body 10 with respect to a wrist is freely changeable.

If there is a human face in an image captured by the camera 12, the CPU 101 obtains an affirmative result in step 21. In this case, similar to the first exemplary embodiment, the CPU 101 determines the relationship between the orientation of the user's face and the position of the camera 12 from the image captured by the camera 12 (step 1). Subsequently, the CPU 101 determines an area of the display 11 that is viewable from the user (step 2).

In contrast, if there is no human face in an image captured by the camera 12, the CPU 101 obtains a negative result in step 21. In this case, the CPU 101 determines an area that is viewable from the user on the basis of the position of the contact sensor 13 detected to be in contact with the user (step 13). The subsequent steps are similar to those in the first and second exemplary embodiments.

In the third exemplary embodiment, even if there is no human face in an image captured by the camera 12, the time information item may be displayed near the center of an area that is highly likely to be viewable from a user. However, in the method of determining an area viewable from a user on the basis of the position of the contact sensor 13 that detects contact, it is assumed that the user looks down a portion of the terminal 1B that is detected to be in contact with the user. Thus, if the user actually looks at a portion of the terminal 1B that is different from the assumption, the displayed time is not always easily viewable from the user. Accordingly, in the third exemplary embodiment, when a user is captured in an image by the camera 12, which is provided on the body 10, the image captured by the camera 12 is used so as to reliably display the time at a position where the time is easily viewable from the user.

### Fourth Exemplary Embodiment

The terminal 1 (see FIGS. 1A to 1C), the terminal 1A (see FIGS. 12A to 12C), and the terminal 1B (see FIGS. 17A to 17C) of the above-described first to third exemplary embodiments are configured on the assumption that the shape of the body 10 does not greatly change. In contrast, in a fourth exemplary embodiment, the case where the degree of freedom in altering the shape of the body 10 is large will be described.

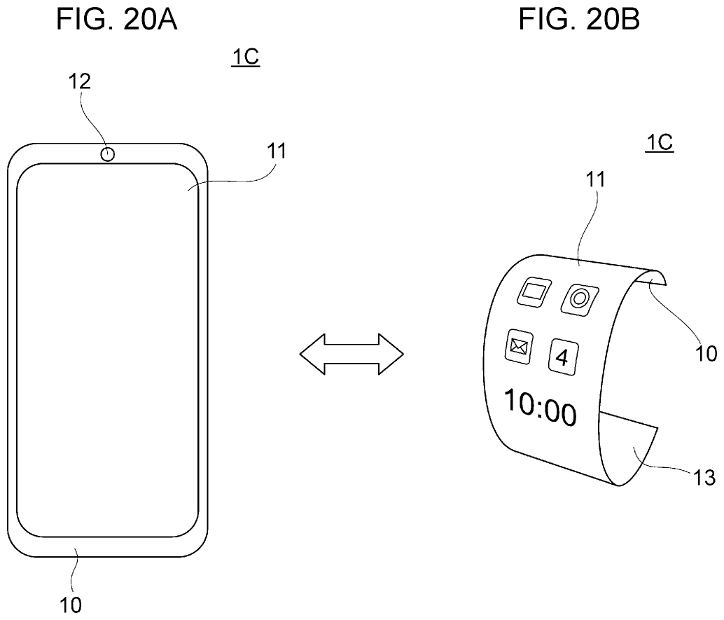

FIGS. 20A and 20B are diagrams illustrating an example of a wearable terminal 1C that is used in the fourth exemplary embodiment. FIG. 20A illustrates a basic shape of the terminal 1C, and FIG. 20B illustrates the terminal 1C after its shape has been altered. In FIGS. 20A and 20B, components that correspond to those illustrated in FIGS. 1A to 1C are denoted by the same reference signs.

The body 10 in the fourth exemplary embodiment may be used in for example, a flat plate-like shape. Alternatively, the body 10 in the fourth exemplary embodiment may be used by being altered its shape into a C-shape or a J-shape when viewed from the side.

FIGS. 20A and 20B, although the shape of the body 10 is altered in such a manner that the display 11 is located on the convex side, the shape of the body 10 may be altered in such a manner that the display 11 is located on the concave side.

Note that the display 11 has flexibility so as to be deformable integrally with the body 10. Here, the display 11 is an example of a display device that is deformable.

In the fourth exemplary embodiment, an area that is viewable from a user is determined by using the contact sensors 13 in addition to the camera 12.

### Fifth Exemplary Embodiment

The terminal 1 (see FIGS. 1A to 1C), the terminal 1A (see FIGS. 12A to 12C), the terminal 1B (see FIGS. 17A to 17C), and the terminal 1C (see FIGS. 20A and 20B) of the above-described first to fourth exemplary embodiments each have the display 11 that displays information. In contrast, in a fifth exemplary embodiment, the case of using a projector instead of the display 11 will be described.

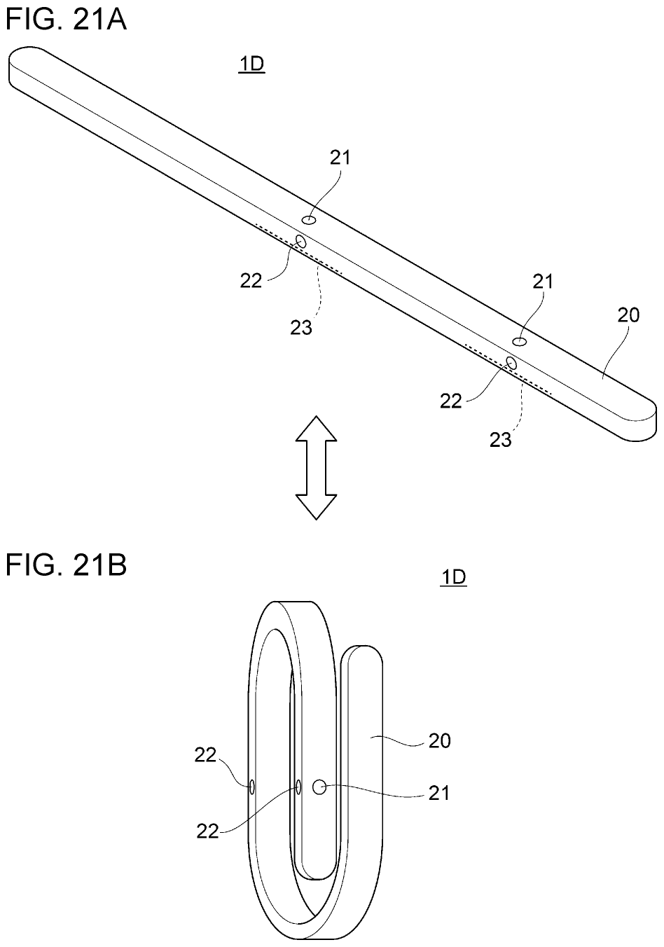

FIGS. 21A and 21B are diagrams illustrating an example of a wearable terminal 1D that is used in the fifth exemplary embodiment. FIG. 21A is a perspective view of the terminal 1D in a stretched state, and FIG. 21B is a perspective view of the terminal 1D whose shape has been altered.

The terminal 1D that is used in the fifth exemplary embodiment is also used by being worn around a wrist.

The terminal 1D in the fifth exemplary embodiment includes a bar-shaped body 20 having a length that enables the body 20 to be wrapped around a wrist. In the fifth exemplary embodiment, the body 20 has a rectangular parallelepiped shape.

Two cameras 21 are arranged on a surface of the body 20, the surface being the front surface of the body 20 when the body 20 is wrapped around a user's wrist, and two projectors 22 are arranged on a side surface of the body 20, the side surface facing a user's arm when the body 20 is wrapped around the user's wrist.

Each of the cameras 21 is paired with one of the projectors 22. In the fifth exemplary embodiment, each pair of the camera 21 and the projector 22 are arranged so as to be at the same distance from an end of the body 20. The two cameras 21 are provided for the purpose of detecting a face of a user who wears the terminal 1D. The two projectors 22 are provided for the purpose of detecting projecting information onto a user's arm.

One of the two cameras 21 corresponds to the projector 22 that projects an image onto a user's arm on the palm side when the body 20 is wrapped around the user's wrist, and the other camera 21 corresponds to the projector 22 that projects an image on the user's arm on the back side of the hand when the body 20 is wrapped around the user's wrist.

A plurality of infrared sensors 23 are arranged in a row below the projectors 22. The infrared sensors 23 that detect a user operation that is performed on an image projected on the user's arm. The area in which the infrared sensors 23 are arranged is set in accordance with the width of an image that is projected onto the user's arm.

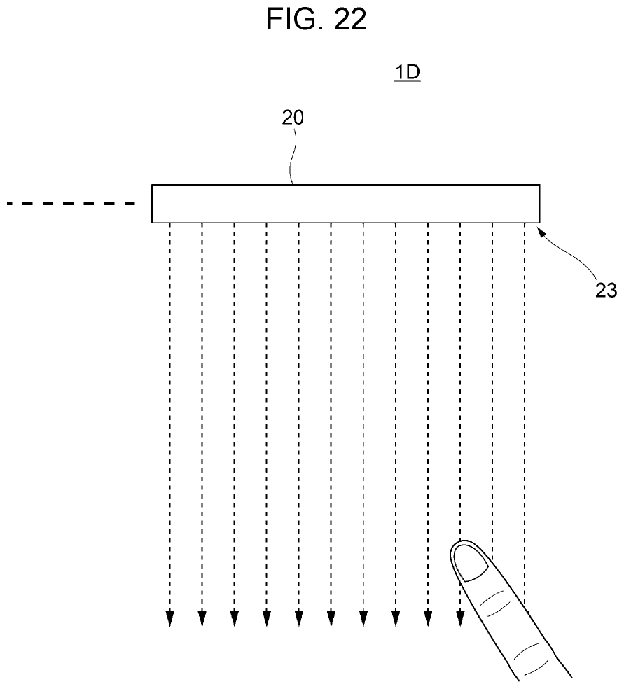

FIG. 22 is a diagram illustrating an output example of infrared light beams that are output by the infrared sensors 23. In the case illustrated in FIG. 22, the third infrared light beam from the right-hand end is obstructed by a fingertip. The infrared light beam is reflected by the fingertip onto the corresponding infrared sensor 23 and detected as a user operation. In the case where an operation button or the like is projected to the position where the infrared light beam is obstructed by the fingertip, an operation performed on the button at the position is detected.

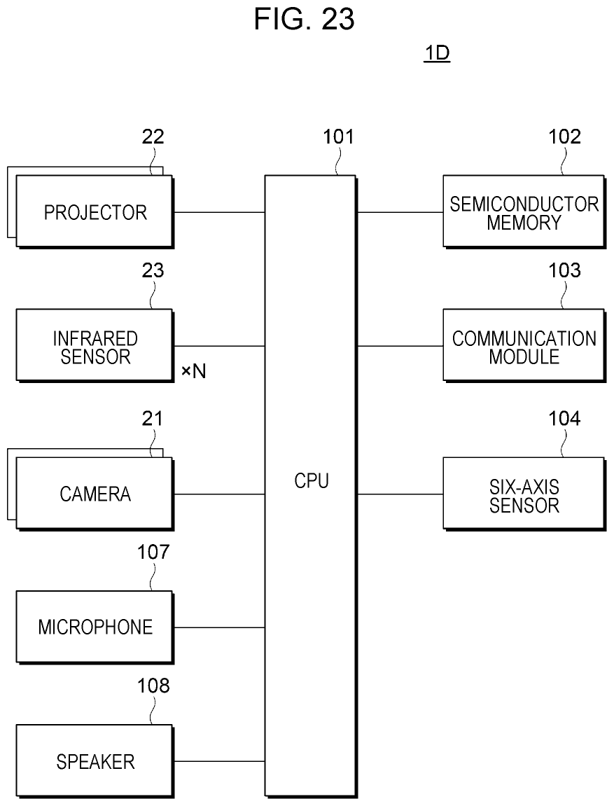

FIG. 23 is a diagram illustrating an example of a configuration of a signal system of the wearable terminal 1D. In FIG. 23, components that correspond to those illustrated in FIG. 2 are denoted by the same reference signs.

The terminal 1D includes the CPU 101 that performs overall control of the device, the semiconductor memory 102 that stores programs and data, the communication module 103 that is used in communication with the outside, the six-axis sensor 104 that detects the movement and posture of a user wearing the terminal 1D, the projectors 22 that project information, the infrared sensors 23 that detect user operations, the cameras 21, the microphone 107, and the speaker 108.

The CPU 101 in the fifth exemplary embodiment sets the arrangement of information items that are projected by the projectors 22 through execution of a program. The CPU 101 is an example of a processor.

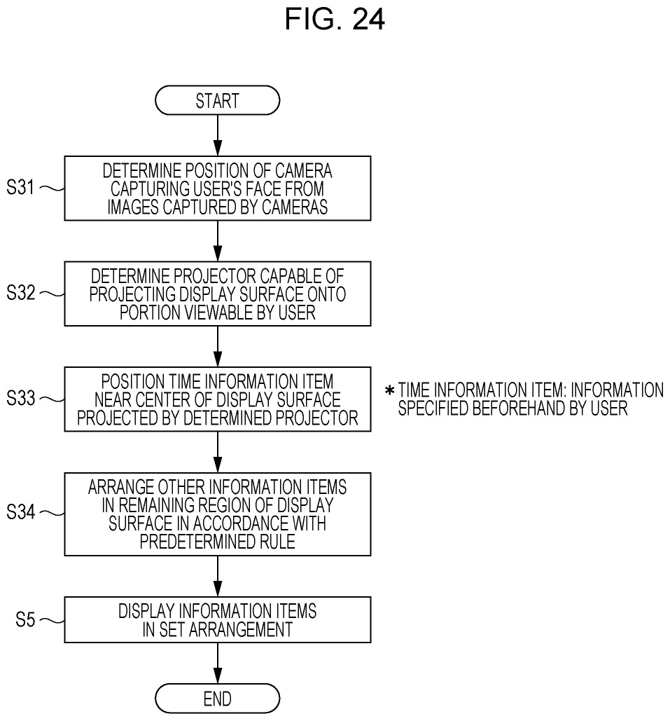

FIG. 24 is a flowchart illustrating an example of a processing operation that is performed in the wearable terminal 1D of the fifth exemplary embodiment. In FIG. 24, steps that are the same as those in the flowchart illustrated in FIG. 3 are denoted by the same reference signs, and the letter “S” is an abbreviation for “step”.

In the fifth exemplary embodiment, the CPU 101 (see FIG. 23) determines the position of one of the cameras 21 that captures a user's face from images captured by the cameras 21 (step 31). In the fifth exemplary embodiment, the CPU 101 determines whether the camera 21 that is located on the back side of the hand when the body 20 is wrapped around the user's wrist or the camera 21 that is located on the palm side when the body 20 is wrapped around the user's wrist captures the user's face.

Once the position of the camera 21 capturing the user's face has been determined, the CPU 101 determines the projector 22 that is capable of projecting a display surface onto a portion of the user's arm that is viewable from the user (step 32). Since each of the cameras 21 is paired with one of the projectors 22, when the position of one of the cameras 21 is determined, the position of the corresponding projector 22 is also determined.

Then, the CPU 101 positions the time information item near the center of the display surface projected by the determined projector 22 (step 33).

Once the position of the time information item has been set, the CPU 101 arranges the other information items in the remaining region of a determined area in accordance with a predetermined rule (step 34).

After that, the CPU 101 causes the information items to be displayed in the set arrangement (step 5).

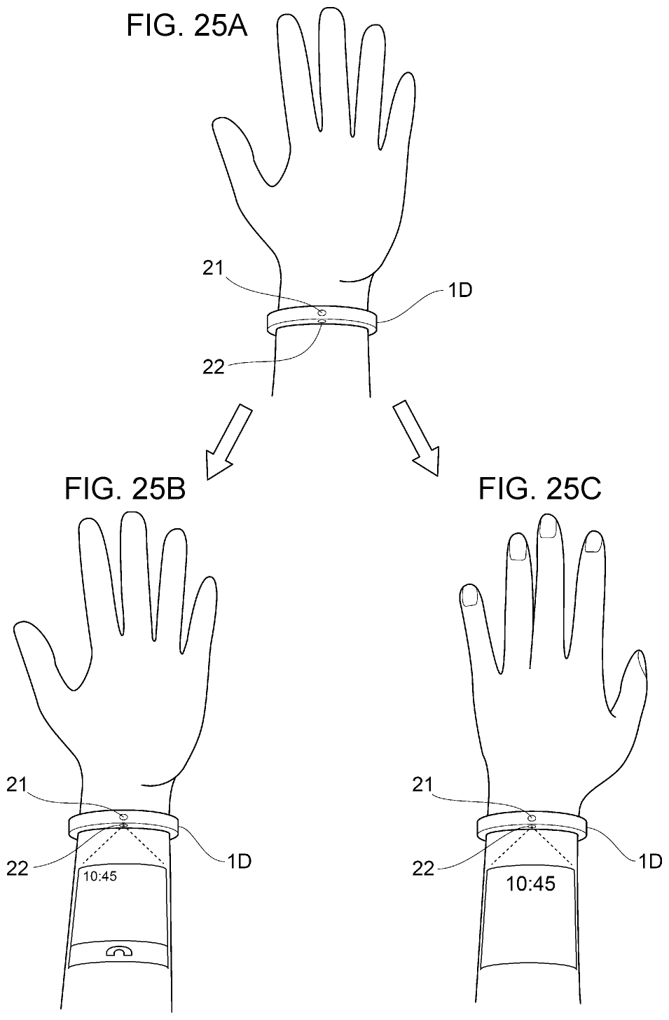

FIGS. 25A to 25C are diagrams illustrating usage examples of the terminal 1D of the fifth exemplary embodiment. FIG. 25A illustrates a state before a display surface is projected by one of the projectors 22. FIG. 25B illustrates a case in which one of the projectors 22 projects the display surface on the palm side. FIG. 25C illustrates a case in which one of the projectors 22 projects the display surface on the back side of a hand.

In the fifth exemplary embodiment, the display surface is projected by the projector 22 that is paired with the camera 21 capturing a user's face, and the time is positioned near the center of the projected display surface.

Note that FIG. 25B illustrates the state where the time is displayed at the upper left corner by being reduced in size due to an incoming call.

### Other Exemplary Embodiments

Although the exemplary embodiments of the present disclosure have been described above, the technical scope of the present disclosure is not limited to the above-described exemplary embodiments. It is obvious from the description of the claims that other exemplary embodiments obtained by making various changes and improvements to the above-described exemplary embodiments are also included in the technical scope of the present disclosure.

For example, in the above-described exemplary embodiments, although an area that is viewable from a user is detected by using the camera 12 (see FIGS. 1A to 1C) and the contact sensors 13, an area that is viewable from a user may be determined by using a deformation sensor that detects a portion of the body 10 that is deformed. As a deformation sensor, for example, a strain sensor or a pressure sensor having flexibility is used. For example, a portion in which a large strain has occurred may be detected as a curved portion, and the curved portion may be used as a reference position for a viewable area.

In the above exemplary embodiments, although the terminal 1 (see FIGS. 1A to 1C) and the like have been described as examples of a device to be worn around a wrist, the present disclosure is applicable to a device to be worn on an arm, a device to be worn on a neck, devices to be worn on an ankle, a calf, a thigh, and other leg parts, and devices to be worn on an abdomen and a chest.

In addition, in each of the above exemplary embodiments, although the case has been described in which the display surface of the terminal has an area extending approximately halfway around a part of a human body on which the terminal is worn, since the display surface has a curved surface, the display 11 may at least have viewability that varies depending on the position where a user looks at the display 11.

Note that, in the above-described exemplary embodiments, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the above-described exemplary embodiments, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
detect a viewable region of a display surface on a user, the viewable region being viewable from the user; and
display predetermined information in an area including the center of the viewable region.

2. The information processing apparatus according to claim 1,
wherein the display surface is a display of a wearable device worn by the user.

3. The information processing apparatus according to claim 2,
wherein the information processing apparatus is the wearable device.

4. The information processing apparatus according to claim 1,
wherein the display surface is a portion of the user on which an image is projected by a projector.

5. The information processing apparatus according to claim 4,
wherein the projector is a projector of the information processing apparatus, and
wherein the information processing apparatus is wearable.

6. The information processing apparatus according to claim 1,
wherein the processor is configured to detect the viewable region from a relationship among a position of the display surface, a position of an imaging device, and an orientation of the user's face that is determined from an image captured by the imaging device.

7. The information processing apparatus according to claim 6,
wherein the processor is configured to detect a direction of the user's line of sight as the orientation of the user's face.

8. The information processing apparatus according to claim 2,
wherein the processor is configured to:
determine a contacting portion of a back of the display, the contacting portion being a portion that is in contact with the user in a state where the user is wearing the display, and
detect the viewable region based on the contacting portion.

9. The information processing apparatus according to claim 8,
wherein the processor is configured to set the center of the viewable region to a position that corresponds to the contacting portion.

10. The information processing apparatus according to claim 8,
wherein the processor is configured to detect the viewable region from a relationship among the contacting portion, a position of an imaging device, and an orientation of the user's face determined from an image captured by the imaging device.

11. The information processing apparatus according to claim 1,
wherein the display surface has a curve to fit the user.

12. The information processing apparatus according to claim 11,
wherein the display is a deformable display.

13. The information processing apparatus according to claim 11,
wherein the display is attached to a cylindrical member.

14. The information processing apparatus according to claim 1,
wherein the predetermined information is information relating to time.

15. The information processing apparatus according to claim 1,
wherein the predetermined information is information relating to communication.

16. The information processing apparatus according to claim 1,
wherein a position at which the predetermined information is displayed is changeable by a user operation.

17. The information processing apparatus according to claim 1,
wherein a position at which information that is positioned outside the viewable region, in which the predetermined information is displayed, is displayed is changeable by a user operation.

18. The information processing apparatus according to claim 1,
wherein the processor is configured to change a display size of the predetermined information in accordance with a size of the region viewable from the user.

19. The information processing apparatus according to claim 1,
wherein the processor is configured to change a number of items of the predetermined information that are displayed in accordance with a size of the viewable region viewable from the user.

20. A non-transitory computer readable medium storing a program causing a computer to execute a process, the process comprising:
detecting a viewable region of a display surface on a user, the viewable region being viewable from the user; and
displaying predetermined information in an area including the center of the viewable region.
